(19) United States
(12) Patent Application Publication
(10) Pub. No.: US 2019/0001818 A1
(43) Pub. Date: Jan. 3, 2019

(54) INFORMATION DISPLAY DEVICE AND INFORMATION DISPLAY METHOD

(71) Applicant: MITSUBISHI ELECTRIC CORPORATION, Tokyo (JP)

(72) Inventors: Reiko SAKATA, Tokyo (JP); Akiko IMAISHI, Tokyo (JP)

(73) Assignee: MITSUBISHI ELECTRIC CORPORATION, Tokyo (JP)

(21) Appl. No.: 16/064,095

(22) PCT Filed: Feb. 12, 2016
(86) PCT No.: PCT/JP2016/054136

§ 371 Date: Jun. 20, 2018

(51) Int. Cl. B60K 35/00; B60Q 1/50; B60R 11/02

(52) U.S. Cl. CPC B60K 35/00; B60Q 1/503; B60R 11/0235; B60K 2350/962; B60K 2350/352; B60K 2350/924; B60K 2350/1096

(57) ABSTRACT

A vehicle state determining unit (1) for determining a state of a vehicle and a display data selecting unit (5) for selecting display data corresponding to the state of the vehicle determined by the vehicle state determining unit (1) out of a plurality of display data for displaying information presented to the outside of the vehicle are provided, and an information displaying unit (8) is configured to display the information to the outside of the vehicle in accordance with the display data selected by the display data selecting unit (5). As a result, it is possible to select and display information contributing to driving safety.

### TECHNICAL FIELD

The present invention relates to an information display device and an information display method for displaying information to the outside of a vehicle.

### BACKGROUND ART

Patent Literature 1 described below discloses an information display device for displaying information to the outside of a vehicle.

The information display device includes a lamp installed in a position visible from a vehicle behind and has a function of controlling lighting of the lamp on the basis of a traveling mode of a user's vehicle.

For example, when the traveling mode of the user's vehicle is “automatic travel”, the lamp is turned on in yellow, and when the traveling mode of the user's vehicle is “manual travel”, the lamp is turned off. Also, when the traveling mode of the user's vehicle switches from the “automatic travel” to the “manual traveling” or from the “manual travel” to the “automatic travel”, the lamp blinks in red.

### CITATION LIST

### Patent Literatures

Patent Literature 1: JP 2002-236993 A (paragraph [0022] and FIG. 5, for example)

### SUMMARY OF INVENTION

### Technical Problem

Since the conventional information display device is configured as described above, it is possible to notify the vehicle behind of the traveling mode of the user's vehicle. However, there is a problem that it is not possible to notify other vehicles of information contributing to driving safety other than the traveling mode of the vehicle.

The present invention is achieved to solve the above-described problem, and an object thereof is to obtain an information display device and an information display method capable of selecting and displaying the information contributing to driving safety.

### Solution to Problem

An information display device according to the present invention includes a vehicle state determining unit for determining a state of a vehicle and a display data selecting unit for selecting display data corresponding to the state of the vehicle determined by the vehicle state determining unit out of a plurality of display data for displaying information to be presented to an outside of the vehicle, and an information displaying unit is configured to display the information to the outside of the vehicle in accordance with the display data selected by the display selecting unit.

### Advantageous Effects of Invention

According to the present invention, a display data selecting unit which selects display data corresponding to a state of a vehicle determined by a vehicle state determining unit out of a plurality of display data for displaying information presented to the outside of the vehicle is provided, and an information displaying unit is configured to display the information to the outside of the vehicle in accordance with the display data selected by the display data selecting unit, so that there is an effect of selecting and displaying information contributing to driving safety.

### BRIEF DESCRIPTION OF DRAWINGS

FIG. 1 is a configuration diagram illustrating an information display device according to a first embodiment of the present invention.

FIG. 2 is a hardware configuration diagram of the information display device according to the first embodiment of the present invention.

FIG. 3 is a hardware configuration diagram of a computer in a case in which the information display device is implemented by software, firmware or the like.

FIG. 4 is a flowchart illustrating an information display method being a procedure of the information display device according to the first embodiment of the present invention.

FIG. 5 is an illustrative view illustrating a correspondence relationship between a state of a vehicle and display data.

FIG. 6A and FIG. 6B are illustrative views illustrating an example in which information indicating that a vehicle travels automatically is displayed on a road surface. FIG. 6C is an illustrative view illustrating an example of displaying information indicating that vehicles travel in formation on the road surface.

FIG. 7 is a configuration diagram illustrating an information display device according to a second embodiment of the present invention.

FIG. 8 is a hardware configuration diagram of the information display device according to the second embodiment of the present invention.

FIG. 9 is a configuration diagram illustrating an information display device according to a third embodiment of the present invention.

FIG. 10 is a hardware configuration diagram of the information display device according to the third embodiment of the present invention.

FIG. 11 is a configuration diagram illustrating an information display device according to a fourth embodiment of the present invention.

FIG. 12 is an illustrative view illustrating an example of a table held by an information displaying unit 11.

FIG. 13 is an illustrative view illustrating an example of the table held by the information displaying unit 11.

FIG. 14A is an illustrative view illustrating an example in which a medium on which information is displayed is a body of a vehicle, FIG. 14B is an illustrative view illustrating an example in which the medium on which the information is displayed is a window of the vehicle, FIG. 14C is an illustrative view illustrating an example in which the medium on which the information is displayed is a display tool formed of a plurality of light emitting devices, and FIG. 14D is an illustrative view illustrating an example in which the medium on which the information is displayed is a display attached to a body of the vehicle.

### DESCRIPTION OF EMBODIMENTS

Modes for carrying out the present invention are hereinafter described with reference to the attached drawings in order to describe the present invention in more detail.

### First Embodiment

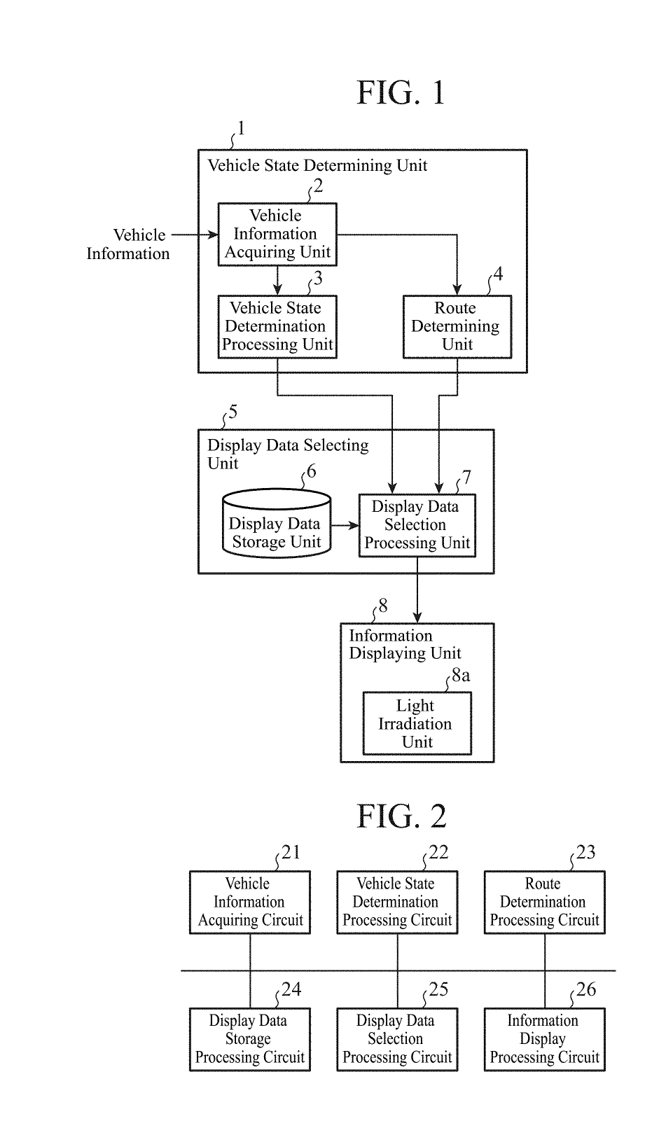

FIG. 1 is a configuration diagram illustrating an information display device according to a first embodiment of the present invention, and FIG. 2 is a hardware configuration diagram of the information display device according to the first embodiment of the present invention.

In FIGS. 1 and 2, a vehicle state determining unit 1 includes a vehicle information acquiring unit 2, a vehicle state determination processing unit 3, and a route determining unit 4 and performs processing of determining a state of a vehicle.

The vehicle information acquiring unit 2 is implemented by a vehicle information acquiring circuit 21 provided with an interface device for an in-vehicle network, for example, such as a controller area network (CAN), and performs processing of acquiring vehicle information indicating the state of the vehicle from an in-vehicle device through the in-vehicle network.

The vehicle information may include, for example, in addition to CAN data including operation information of a blinker, a steering wheel, an accelerator, a brake, and a shift lever, information output from a car navigation device, information output from a contact sensor mounted on the vehicle, visual information of a camera which takes a photograph of the surroundings of the vehicle and the like.

The information output from the car navigation device may include position information indicating a position of the vehicle, map information, route guidance information indicating a route to a destination of the vehicle and the like.

Also, the information output from the contact sensor may include, for example, operation detection information and the like in a case in which operation within a range of play is performed on the steering wheel, the accelerator, and the brake.

The vehicle state determination processing unit 3 is implemented by a vehicle state determination processing circuit 22 in FIG. 2, for example, and performs the processing of determining the state of the vehicle from the vehicle information acquired by the vehicle information acquiring unit 2.

The route determining unit 4 is implemented by, for example, a route determination processing circuit 23 in FIG. 2 and performs processing of determining a travel route of the vehicle as the state of the vehicle from the operation information of the blinker and the position information, the map information, and the route guidance information output from the car navigation device out of the vehicle information acquired by the vehicle information acquiring unit 2.

The display data selecting unit 5 includes a display data storage unit 6 and a display data selection processing unit 7.

The display data storage unit 6 is implemented by, for example, a display data storage processing circuit 24 in FIG. 2 and stores display data for displaying information to be presented to the outside the vehicle for each state of the vehicle. The display data stored in the display data storage unit 6 is, for example, animated display data including the information to be presented to the outside of the vehicle.

The display data selection processing unit 7 is implemented by, for example, a display data selection processing circuit 25 in FIG. 2 and performs processing of selecting the display data corresponding to the state of the vehicle determined by the vehicle state determination processing unit 3 and the route determining unit 4 out of a plurality of display data stored in the display data storage unit 6.

An information displaying unit 8 is implemented by, for example, an information display processing circuit 26 in FIG. 2 and performs processing of displaying the information to the outside of the vehicle in accordance with the display data selected by the display data selection processing unit 7.

That is, the information displaying unit 8 includes a light irradiation unit 8a which displays the information indicating the state of the vehicle on a projection surface by irradiating the projection surface outside the vehicle with, for example, laser light or light emitting diode (LED) light in accordance with the display data selected by the display data selection processing unit 7.

The surface on which the light is projected may include a road surface around the vehicle, a body of the vehicle, a window of the vehicle and the like, and the body and the window of the vehicle are included as the projection surface outside the vehicle.

An example in which a medium on which information is displayed by the information displaying unit 8 is the road surface around the vehicle and the body and the window of the vehicle is herein described; however, for example, the information displaying unit 8 may display the information on a display tool and a display by using the display tool formed of a plurality of light emitting devices attached in a lighting tool such as a headlight and a stop light or attached to the body and the like of the vehicle, or by using the display attached to the body and the like of the vehicle as a display medium.

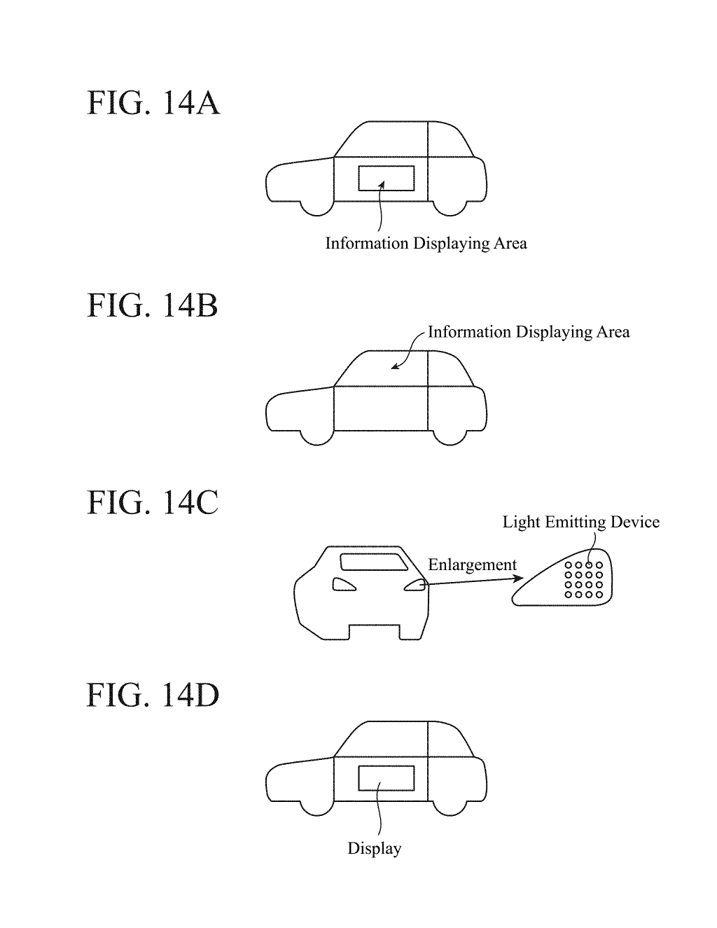

FIG. 14 is illustrative views each illustrating an example of the medium on which the information is displayed by the information displaying unit 8.

FIG. 14A illustrates an example in which the medium on which the information is displayed is the body of the vehicle, FIG. 14B illustrates an example in which the medium on which the information is displayed is the window of the vehicle, FIG. 14C illustrates an example in which the medium on which the information is displayed is the display tool formed of a plurality of light emitting devices, and FIG. 14D illustrates an example in which the medium on which the information is displayed is the display attached to the body of the vehicle.

In FIG. 1, the vehicle information acquiring unit 2, the vehicle state determination processing unit 3, the route determining unit 4, the display data storage unit 6, the display data selection processing unit 7, and the information displaying unit 8 being components of the information display device are assumed to be implemented by dedicated hardware as illustrated in FIG. 2, that is, the vehicle information acquiring circuit 21, the vehicle state determination processing circuit 22, the route determination processing circuit 23, the display data storage processing circuit 24, the display data selection processing circuit 25, and the information display processing circuit 26, respectively.

Herein, the display data storage processing circuit 24 corresponds to, for example, a non-volatile or volatile semiconductor memory such as a random access memory (RAM), a read only memory (ROM), a flash memory, an erasable programmable read only memory (EPROM), and an electrically erasable programmable read only memory (EEPROM), a magnetic disk, a flexible disk, an optical disc, a compact disc, a mini disc, a digital versatile disc (DVD) and the like.

Also, each of the vehicle information acquiring circuit 21, the vehicle state determination processing circuit 22, the route determination processing circuit 23, the display data selection processing circuit 25, and the information display processing circuit 26 corresponds to, for example, a single circuit, a composite circuit, a programmed processor, a parallel-programmed processor, an application specific integrated circuit (ASIC), a field-programmable gate array (FPGA), or a combination thereof.

Also, the components of the information display device are not limited to those implemented by the dedicated hardware, and the information display device may also be implemented by software, firmware, or a combination of the software and firmware.

The software and firmware are stored as a program in a memory of a computer. The computer is intended to mean the hardware which executes the program, and corresponds to, for example, a central processing unit (CPU), a central processor, a processing unit, an arithmetic unit, a microprocessor, a microcomputer, a processor, a digital signal processor (DSP) and the like.

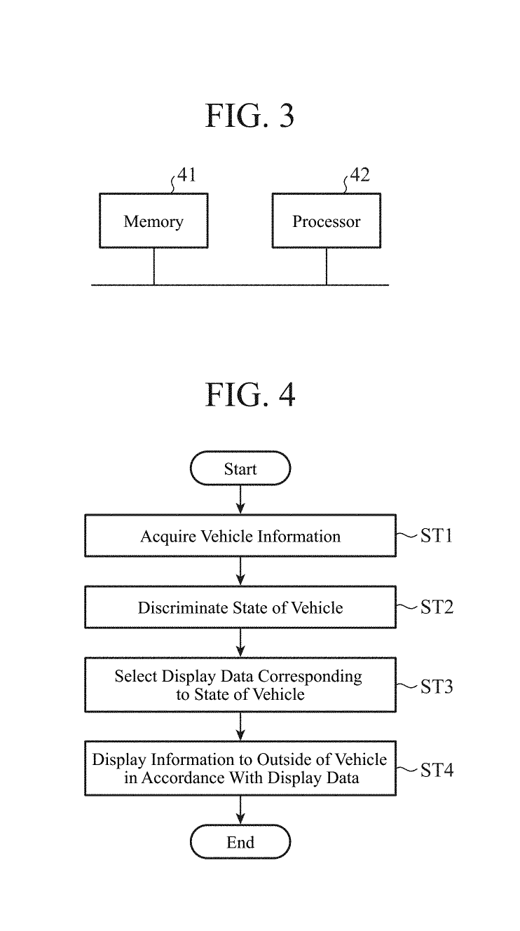

FIG. 3 is a hardware configuration diagram of the computer in a case in which the information display device is implemented by the software, firmware and the like.

In a case in which the information display device is implemented by the software, firmware and the like, the display data storage unit 6 may be configured on a memory 41 of the computer and a program for allowing the computer to execute procedures of the vehicle information acquiring unit 2, the vehicle state determination processing unit 3, the route determining unit 4, the display data selection processing unit 7, and the information displaying unit 8 may be stored in the memory 41, and a processor 42 of the computer may execute the program stored in the memory 41.

FIG. 4 is a flowchart illustrating an information display method which is the procedure of the information display device according to the first embodiment of the present invention.

Also, FIG. 2 illustrates an example in which each of the components of the information display device is implemented by the dedicated hardware, and FIG. 3 illustrates an example in which the information display device is implemented by the software, firmware and the like; however, some components in the information display device may be implemented by the dedicated hardware and remaining components may be implemented by the software, firmware and the like.

For example, the vehicle information acquiring unit 2 and the information displaying unit 8 may be implemented by the dedicated hardware, and the vehicle state determination processing unit 3, the route determining unit 4, the display data storage unit 6, and the display data selection processing unit 7 may be implemented by the software, firmware and the like. A combination of the dedicated hardware, software and the like is freely selected.

Next, operations will be described.

The vehicle information acquiring unit 2 of the vehicle state determining unit 1 acquires the vehicle information indicating the state of the vehicle from the in-vehicle device through the in-vehicle network and outputs the vehicle information to the vehicle state determination processing unit 3 and the route determining unit 4 (step ST1 in FIG. 4).

In the first embodiment, as the vehicle information, the information output from the car navigation device, the information output from the contact sensor mounted on the vehicle and the like are acquired, for example, in addition to the CAN data.

Upon receiving the vehicle information from the vehicle information acquiring unit 2, the vehicle state determination processing unit 3 determines the state of the vehicle from the vehicle information (step ST2).

Hereinafter, determination examples of the vehicle state by the vehicle state determination processing unit 3 are listed. However, the determination examples listed are illustrative only, and other determination may be performed in some cases.

### Determination Example A

For example, in a case in which a position of a shift lever included in the CAN data is “parking position”, it is determined that the vehicle is stopping.

### Determination Example B

For example, when the position of the shift lever included in the CAN data is “drive position” and a speed indicated by speed information of the vehicle included in the CAN data is not 0 km/h, it is determined that the vehicle is traveling.

However, even when the speed is 0 km/h, in a case in which the position of the shift lever is not the “parking position”, it is determined that the vehicle is traveling.

### Determination Example C

When the vehicle is traveling, when the information indicating a traveling mode of the vehicle included in the CAN data indicates “manual travel”, it is determined that the vehicle is in a manual traveling state in which the vehicle travels by manual operation.

### Determination Example D

When the vehicle is traveling, when the information indicating the traveling mode of the vehicle included in the CAN data indicates “automatic travel”, it is determined that the vehicle is in an automatic traveling state in which the vehicle travels by automatic operation.

### Determination Example E

When the vehicle is traveling, when the information indicating the traveling mode of the vehicle included in the CAN data indicates “formation travel”, it is determined that the vehicle is in a formation traveling state in which the vehicle travels in formation with other vehicles.

### Determination Example F

When the vehicle is traveling, when the information indicating the traveling mode of the vehicle included in the CAN data switches from the “manual travel” to the “automatic travel”, it is determined that the traveling mode of the vehicle is being switched from the “manual travel” to the “automatic travel”.

### Determination Example G

When the vehicle is traveling, when the information indicating the traveling mode of the vehicle included in the CAN data switches from the “manual travel” or “automatic travel” to the “formation travel”, it is determined that the traveling mode of the vehicle is being switched from the “manual travel” or “automatic travel” to the “formation travel”.

### Determination Example H

For example, when the vehicle is stopping, and a distance between a side strip and the vehicle is equal to or shorter than a threshold, it is determined that the vehicle is parked on a street. The distance from the side strip to the vehicle may be calculated by referring to the position information and the map information output from the car navigation device. The threshold may be 50 cm, for example.

When the vehicle is parked on the street, and the position of the shift lever included in the CAN data is changed from “parking position” to “drive position”, it is determined that the vehicle is in a state of starting from on-street parking.

Upon receiving the vehicle information from the vehicle information acquiring unit 2, the route determining unit 4 of the vehicle state determining unit 1 determines the travel route of the vehicle as the state of the vehicle from the operation information of the blinker and the position information, the map information, and the route guidance information output from the car navigation device out of the vehicle information.

The determination examples of the travel route of the vehicle by the route determining unit 4 are listed below. However, the determination examples listed are illustrative only, and other determination may be performed in some cases.

### Determination Example I

For example, when the operation information of the blinker included in the CAN data indicates right turn or left turn, the travel route of the vehicle is determined by collating a current position indicated by the position information output from the car navigation device with the map information and searching the road on which the vehicle may turn to right or left. Since the technology of searching for the road on which the vehicle may turn to right or left is a well-known technology, the detailed description thereof is omitted.

### Determination Example J

The travel route of the vehicle is determined from the position information, the map information, or the route guidance information output from the car navigation device.

For example, in a case of traveling on an express highway, it is determined that the vehicle approaches a junction of a main lane and a branch lane.

The display data storage unit 6 of the display data selecting unit 5 stores the display data for displaying the information to be presented to the outside the vehicle for each state of the vehicle.

The display data is, for example, the animated display data including the information to be presented to the outside the vehicle. The animated display data is, for example, data of a moving image pattern by which directionality of a traveling direction is transmitted such as a pattern and an arrow conforming to general road rules.

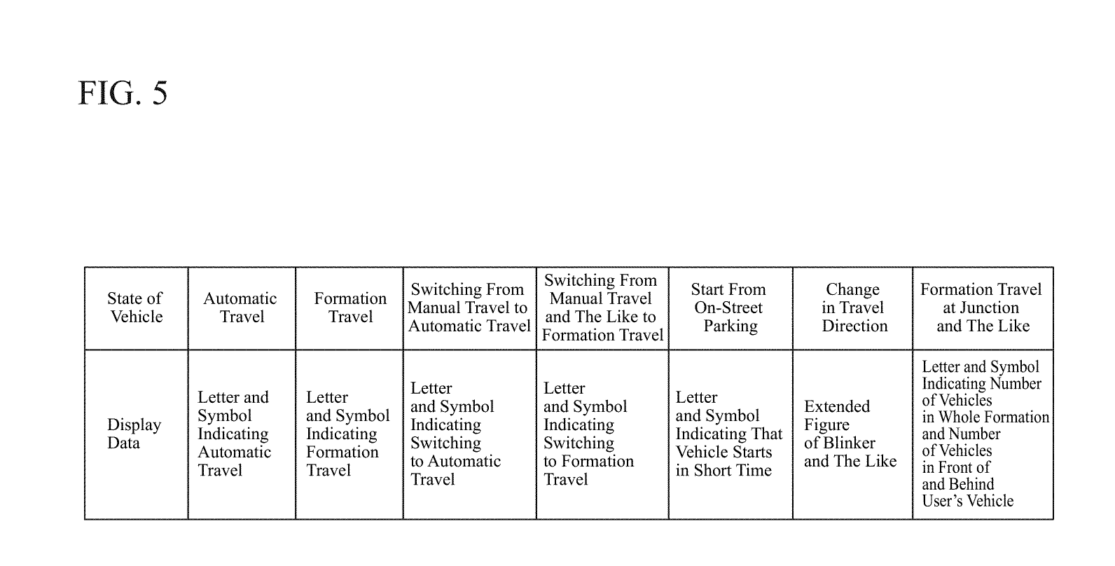

FIG. 5 is an illustrative view illustrating a correspondence relationship between the state of the vehicle and the display data.

The display data selection processing unit 7 selects the display data corresponding to the state of the vehicle determined by the vehicle state determination processing unit 3 and the route determining unit 4 out of a plurality of display data stored in the display data storage unit 6 and outputs the display data to the information displaying unit 8 (step ST3 in FIG. 4).

Hereinafter, selection examples of the display data by the display data selection processing unit 7 are listed. However, the selection examples listed are merely examples, and other selections may be made.

For example, in a case in which the determination result of the vehicle state determination processing unit 3 corresponds to the above-described “determination example D”, the display data of a letter or a symbol indicating that the vehicle is in the automatic travel is selected to be displayed on a front surface, a side surface, and a rear surface of the body of the vehicle, a window on the side surface and the rear surface of the vehicle, or a road surface in front of, lateral to, and behind the vehicle, for example, in order to inform passengers of other vehicles and pedestrians that the vehicle is automatically travelling.

For example, in a case in which the determination result of the vehicle state determination processing unit 3 corresponds to the above-described “determination example F”, the display data of a letter or a symbol indicating that the traveling mode is switching to the automatic travel is selected to be displayed on the front surface, the side surface, and the rear surface of the body of the vehicle, the window on the side surface and the rear surface of the vehicle, or the road surface in front of, lateral to, and behind the vehicle, for example, in order to inform the passengers of other vehicles and pedestrians that the traveling mode switches from the “manual travel” to the “automatic travel” in a short time.

For example, in a case in which the determination result of the vehicle state determination processing unit 3 corresponds to the above-described “determination example H”, the display data of a letter or a symbol indicating that the vehicle starts in a short time is selected to be displayed on the front surface, the side surface, and the rear surface of the body of the vehicle, the window on the side surface and the rear surface of the vehicle, or the road surface in front of, lateral to, and behind the vehicle, for example, in order to inform the passengers of other vehicles and pedestrians that the vehicle starts in a short time.

For example, in a case in which the determination result of the route determining unit 4 corresponds to the above-described “determination example I”, the display data of an extended figure of the blinker indicating a direction in which the vehicle travels and the like is selected to be displayed on the side surface and the rear surface of the body of the vehicle, the window on the side surface and the rear surface of the vehicle, or the road surface lateral to and behind the vehicle, for example, in order to inform the passengers of other vehicles and the pedestrians of the travel route of the vehicle.

For example, in a case in which the determination result of the vehicle state determination processing unit 3 corresponds to the above-described “determination example G”, the display data of a letter or a symbol indicating that the traveling mode is switching to the formation travel is selected to be displayed on the rear surface of the body of the vehicle, the window on the rear surface of the vehicle, or the road surface behind the vehicle, for example, in order to instruct the passengers of other vehicles and the like that the traveling mode switches from the “manual travel” or the “automatic travel” to the “formation travel” in a short time.

For example, in a case in which the determination result of the vehicle state determination processing unit 3 corresponds to the above-described “determination example E” and the determination result of the route determining unit 4 corresponds to the above-described “determination example J”, the display data of a letter or a symbol indicating the number of vehicles in the entire formation, the number of vehicles in front of and behind the user's vehicle, and the position of the user's vehicle is selected to be displayed on the side surface of the body of the vehicle, the window on the side surface of the vehicle, or the road surface to the side of the vehicle.

Upon receiving the display data from the display data selection processing unit 7, the information displaying unit 8 displays the information to the outside of the vehicle in accordance with the display data (step ST4 in FIG. 4).

That is, the light irradiation unit 8a of the information displaying unit 8 displays the information indicating the state of the vehicle on the projection surface by irradiating the projection surface outside the vehicle with the laser light or the LED light, for example, in accordance with the display data output from the display data selection processing unit 7.

In the first embodiment, for the purpose of description, the display data output from the display data selection processing unit 7 includes irradiation position information indicating at which position the light is irradiated, in addition to the animated display data. Therefore, by referring to the irradiation position information, the information displaying unit 8 controls the light irradiation position by the light irradiation unit 8a. An example of a case in which the irradiation position information is not included in the display data will be described in a fourth embodiment.

Herein, an example in which the light irradiation unit 8a of the information displaying unit 8 displays the information to the outside of the vehicle is illustrated, but the information displaying unit 8 may also display the information on the display tool formed of a plurality of light emitting devices and attached to the vehicle.

The information displaying unit 8 may also display the information on the display attached to the body and the like of the vehicle.

Meanwhile, since the display data output from the display data selection processing unit 7 is the animated display data, the information displayed by the information displaying unit 8 changes with the lapse of time, but the same information may also be displayed for a certain time period.

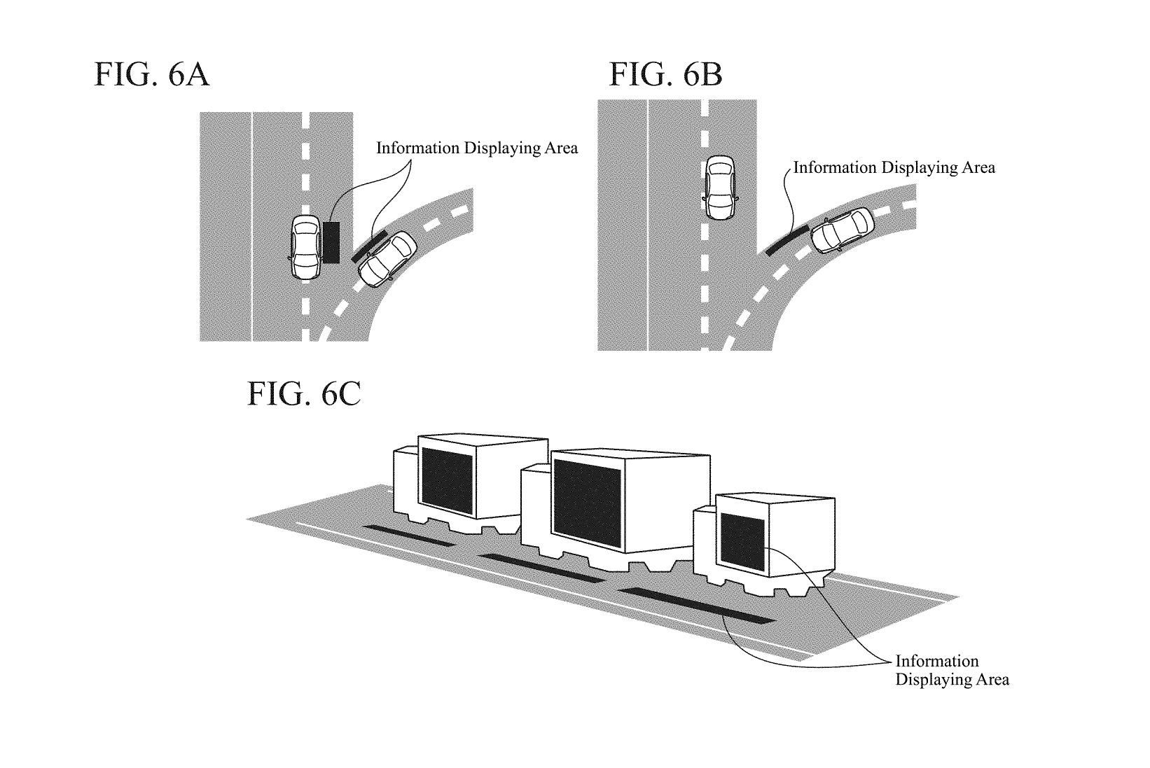

Herein, FIG. 6 is an illustrative view illustrating a display example of the information by the information displaying unit 8.

FIG. 6A and FIG. 6B illustrate an example in which the information indicating that the vehicle is in the automatic travel is displayed on the road surface. In the example in FIG. 6A, the vehicle traveling on the main lane of the express highway displays information indicating that the vehicle travels automatically on the road surface of the left side from a point before the junction. Also, the vehicle traveling on the branch lane of the express highway displays information indicating that the vehicle travels automatically on the road surface of the right side from a point before the junction.

In the example in FIG. 6B, the vehicle traveling the branch lane of the express highway displays information indicating that the vehicle travels automatically on the road surface on the right front side from a point before the junction.

FIG. 6C illustrates an example in which the information indicating that vehicles travel in formation is displayed on the road surface. In the example in FIG. 6C, the information indicating that the vehicles travel in formation is displayed on the side face of the body of the vehicle and on the road surface to the side.

As is clear from the above description, according to the first embodiment, the display data selecting unit 5 which selects the display data corresponding to the state of the vehicle determined by the vehicle state determining unit 1 out of a plurality of display data for displaying the information to be presented to the outside of the vehicle is provided, and the information displaying unit 8 displays information to the outside of the vehicle in accordance with the display data selected by the display data selecting unit 5, so that an effect of selecting and displaying information contributing to driving safety to display is obtained.

As a result, for example, it is possible to prevent occurrence of contact accident and catching accident in the vicinity of the junction of the express highway and intersections.

### Second Embodiment

In the above-described first embodiment, it is described that the information displaying unit 8 displays information to the outside of the vehicle in accordance with display data selected by the display data selecting unit 5, but in a second embodiment, it is described that display data selected by the display data selecting unit 5 is processed in accordance with a state of a vehicle determined by a vehicle state determining unit 1 and information is displayed to the outside of the vehicle in accordance with the processed display data.

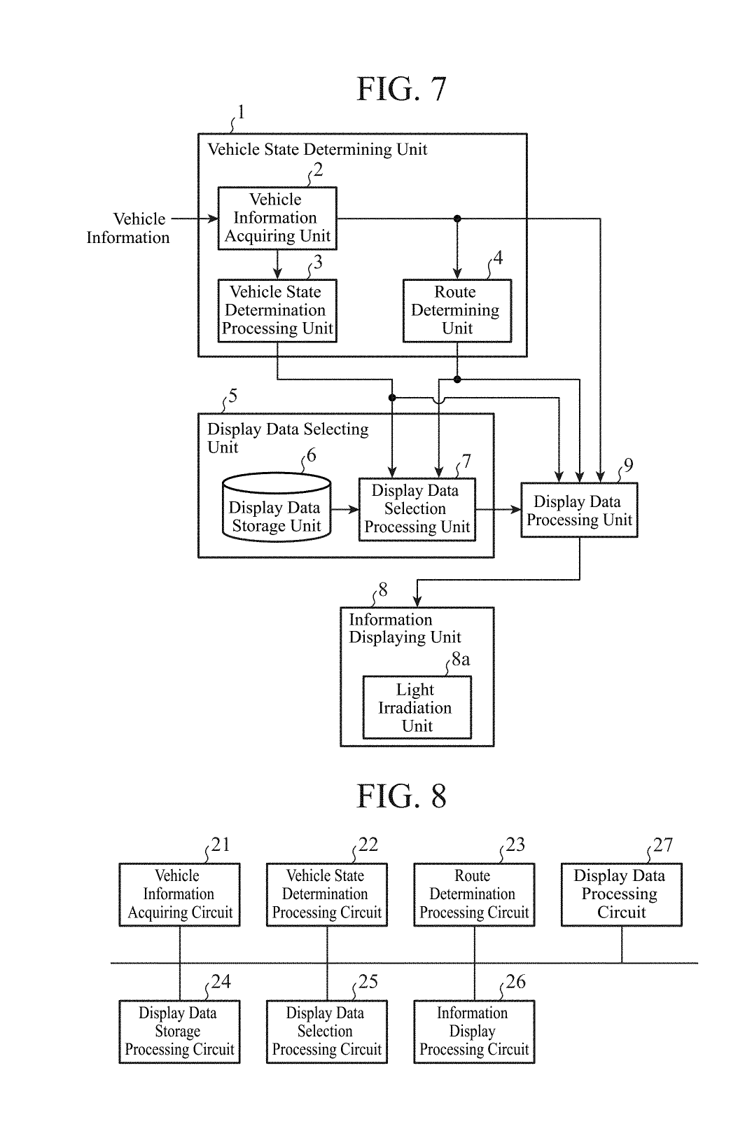

FIG. 7 is a configuration diagram illustrating an information display device according to the second embodiment of the present invention, and FIG. 8 is a hardware configuration diagram of the information display device according to the second embodiment of the present invention.

In FIGS. 7 and 8, the same reference signs as those in FIGS. 1 and 2 represent the same or corresponding parts, so that the description thereof is omitted.

A display data processing unit 9 implemented by, for example, a display data processing circuit 27 in FIG. 8 formed of a semiconductor integrated circuit on which a CPU is mounted, a one-chip microcomputer or the like performs the process of display data selected by a display data selection processing unit 7 in accordance with vehicle information acquired by a vehicle information acquiring unit 2 or a state of the vehicle determined by a vehicle state determination processing unit 3 and a route determining unit 4 and outputting the processed display data to the information displaying unit 8.

In FIG. 7, the vehicle information acquiring unit 2, the vehicle state determination processing unit 3, the route determining unit 4, a display data storage unit 6, the display data selection processing unit 7, the display data processing unit 9, and the information displaying unit 8 being components of the information display device are assumed to be implemented by dedicated hardware as illustrated in FIG. 8, that is, a vehicle information acquiring circuit 21, a vehicle state determination processing circuit 22, a route determination processing circuit 23, a display data storage processing circuit 24, a display data selection processing circuit 25, the display data processing circuit 27, and the information display processing circuit 26, respectively.

However, the components of the information display device are not limited to those implemented by the dedicated hardware, and the information display device may also be implemented by software, firmware, or a combination of the software and firmware.

In a case in which the information display device is implemented by the software, firmware and the like, the display data storage unit 6 may be configured on the memory 41 of the computer illustrated in FIG. 3 and a program for allowing the computer to execute procedures of the vehicle information acquiring unit 2, the vehicle state determination processing unit 3, the route determining unit 4, the display data selection processing unit 7, the display data processing unit 9, and the information displaying unit 8 may be stored in the memory 41, and the processor 42 of the computer may execute the program stored in the memory 41.

Next, operations will be described.

However, the components other than the display data processing unit 9 are similar to those of the first embodiment, so that processing content of the display data processing unit 9 is herein mainly described.

When the display data processing unit 9 receives the display data from the display data selection processing unit 7, the display data processing unit 9 processes the display data in accordance with the vehicle information acquired by the vehicle information acquiring unit 2 or the state of the vehicle determined by the vehicle state determination processing unit 3 and the route determining unit 4 and outputs the processed display data to the information displaying unit 8.

That is, for example, the display data processing unit 9 processes the display data on the basis of a speed of the vehicle included in the vehicle information acquired by the vehicle information acquiring unit 2.

Specifically, for example, as the vehicle speed increases, the display data is processed so as to enlarge a range of light to be irradiated to a road surface such that the information is displayed in a wider range, and visibility in a case of high-speed travel is improved.

Also, as the speed of the vehicle increases, the display data is processed such that a playback speed of animation increases, for example, thereby transmitting a sense of speed of the vehicle.

The display data processing unit 9 also processes the display data in accordance with a travel route being the state of the vehicle determined by the route determining unit 4.

Specifically, for example, in a case in which a traveling direction of the vehicle changes, the display data is processed such that a display position of an extended figure of a blinker indicating the traveling direction of the vehicle changes, thereby enabling intuitive understanding of the traveling direction. For example, the display position of the extended figure of the blinker is changed from a road surface on a right front side of the vehicle−>the road surface on a right side−>the road surface on a right rear side−> . . . −>the road surface on the right front side−>the road surface on the right side−>the road surface on the right rear side when the vehicle moves to the right.

The display data processing unit 9 also processes the display data in accordance with the state of the vehicle determined by the vehicle state determination processing unit 3.

Specifically, for example, in a case in which the vehicle is in a state of starting from on-street parking, the display data is processed such that the display position of a symbol and the like indicating a starting sign of the vehicle is changed, thereby enabling the intuitive understanding of vehicle start. For example, the display position of the symbol indicating the starting sign of the vehicle is changed from the road surface on the right side of the vehicle−>the road surface slightly forward on the right−>the road surface on the right front side−> . . . −>the road surface on the right side−>the road surface slightly forward on the right−>the road surface on the right front side.

Upon receiving the processed display data from the display data processing unit 9, the information displaying unit 8 displays the information to the outside of the vehicle in accordance with the display data as in the first embodiment.

As is clear from the above description, according to the second embodiment, the display data processing unit 9 which processes the display data selected by the display data selection processing unit 7 in accordance with the vehicle information acquired by the vehicle information acquiring unit 2 or the state of the vehicle determined by the vehicle state determination processing unit 3 and the route determining unit 4 is provided, and the information displaying unit 8 is configured to display the information to the outside of the vehicle in accordance with the display data processed by the display data processing unit 9, so that an effect similar to that of the above-described first embodiment may be obtained and an effect of increasing visibility of the information depending on the state of the vehicle may be obtained.

### Third Embodiment

In the above-described first and second embodiments, it is described that the information displaying unit 8 displays information to the outside of the vehicle in accordance with display data, but in a third embodiment, it is described that a situation around the vehicle is monitored and the display of information in the information displaying unit 8 is controlled in accordance with a monitoring result of the situation.

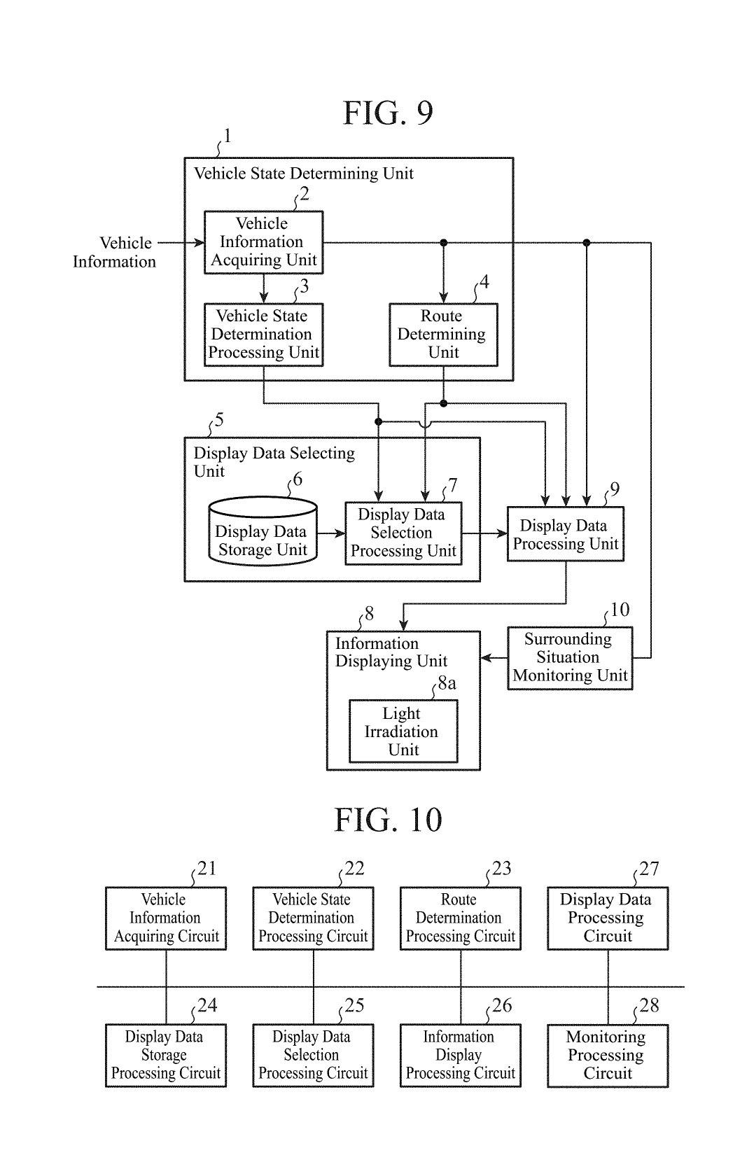

FIG. 9 is a configuration diagram illustrating an information display device according to the third embodiment of the present invention, and FIG. 10 is a hardware configuration diagram of the information display device according to the third embodiment of the present invention.

In FIGS. 9 and 10, the same reference signs as those in FIGS. 1, 2, 7, and 8 represent the same or corresponding parts, so that the description thereof is omitted.

A surrounding situation monitoring unit 10 implemented by, for example, a monitoring processing circuit 28 in FIG. 10 formed of a semiconductor integrated circuit on which a CPU is mounted, a one-chip microcomputer or the like performs processing of monitoring the situation around the vehicle by visual information of a camera which takes a photograph of the surroundings of the vehicle out of vehicle information acquired by a vehicle information acquiring unit 2 and controlling the display of the information in the information displaying unit 8 in accordance with the monitoring result of the situation around the vehicle.

In the third embodiment, an example in which the surrounding situation monitoring unit 10 is used to the information display device of the above-described second embodiment is described, but the surrounding situation monitoring unit 10 may also be used to the information display device of the above-described first embodiment.

In FIG. 9, the vehicle information acquiring unit 2, a vehicle state determination processing unit 3, a route determining unit 4, a display data storage unit 6, a display data selection processing unit 7, a display data processing unit 9, the surrounding situation monitoring unit 10, and the information displaying unit 8 being components of the information display device are assumed to be implemented by dedicated hardware illustrated in FIG. 10, that is, a vehicle information acquiring circuit 21, a vehicle state determination processing circuit 22, a route determination processing circuit 23, a display data storage processing circuit 24, a display data selection processing circuit 25, a display data processing circuit 27, the monitoring processing circuit 28, and an information display processing circuit 26, respectively.

However, the components of the information display device are not limited to those implemented by the dedicated hardware, and the information display device may also be implemented by software, firmware, or a combination of the software and firmware.

In a case in which the information display device is implemented by the software, firmware and the like, the display data storage unit 6 may be configured on the memory 41 of the computer illustrated in FIG. 3 and a program for allowing the computer to execute procedures of the vehicle information acquiring unit 2, the vehicle state determination processing unit 3, the route determining unit 4, the display data selection processing unit 7, the display data processing unit 9, the surrounding situation monitoring unit 10, and the information displaying unit 8 may be stored in the memory 41, and the processor 42 of the computer may execute the program stored in the memory 41.

Next, operations will be described.

However, the components other than the surrounding situation monitoring unit 10 are similar to those of the above-described first and second embodiments, so that processing content of the surrounding situation monitoring unit 10 is herein described.

The surrounding situation monitoring unit 10 monitors the situation around the vehicle by the visual information of the camera which takes a photograph of the surroundings of the vehicle out of the vehicle information acquired by the vehicle information acquiring unit 2.

By executing a well-known object recognition processing algorithm, the surrounding situation monitoring unit 10 detects other vehicles, pedestrians and the like present in an image from the visual information of the camera.

When other vehicles, pedestrians and the like are present around a user's vehicle, for example, in front of, lateral to, lateral front side of, lateral rear side of, and behind the vehicle, the surrounding situation monitoring unit 10 allows the information displaying unit 8 to execute processing of displaying the information in accordance with the display data.

When no other vehicle, pedestrian or the like is present around the user's vehicle, the surrounding situation monitoring unit 10 allows the information displaying unit 8 to stop executing the processing of displaying the information.

As a result, in a case in which there is no other party to present the information such as a case in which there is no other vehicle, pedestrian or the like around the user's vehicle, useless information display may be stopped.

### Fourth Embodiment

In the above-described first to third embodiments, an example is described in which the information displaying unit 8 controls a light irradiation position by the irradiation device by referring to the irradiation position information supposing that the display data output from the display data selection processing unit 7 includes the irradiation position information indicating at which position the light is irradiated, in addition to animated display data.

In the fourth embodiment, an example is described in which an information displaying unit 11 switches a position on a road surface on which information is displayed in accordance with a state of a vehicle determined by a vehicle state determining unit 1 because the irradiation position information is not included in the display data output from the display data selection processing unit 7.

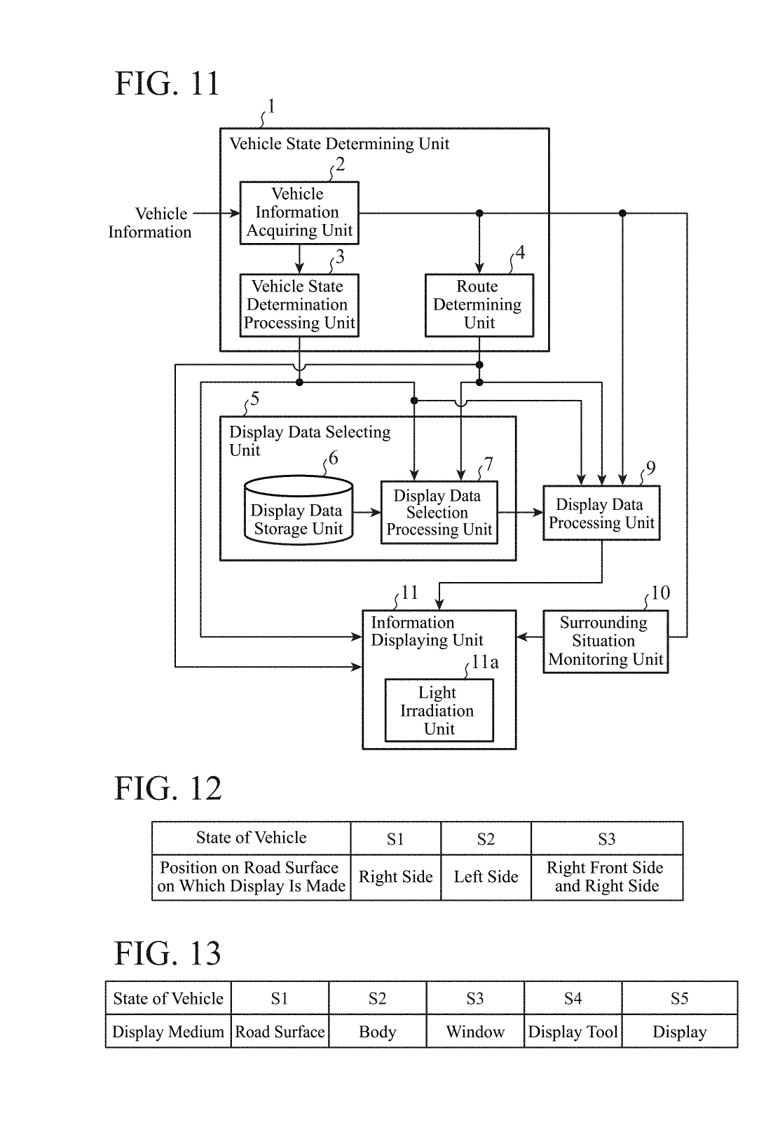

FIG. 11 is a configuration diagram illustrating an information display device according to the fourth embodiment of the present invention; in FIG. 11, the same reference sign as that in FIGS. 1, 7, and 9 represents the same or corresponding part, so that the description thereof is omitted.

An information displaying unit 11 including a light irradiation unit 11a is implemented by the information display processing circuit 26 in FIG. 2, FIG. 8, or FIG. 10, for example.

Similar to the information displaying unit 8 in FIGS. 1, 7, and 9, the information displaying unit 11 performs processing of displaying the information to the outside of the vehicle in accordance with the display data.

However, unlike the information displaying unit 8 in FIGS. 1, 7, and 9, the information displaying unit 11 performs processing of switching the position on the road surface on which the information is displayed in accordance with the state of the vehicle determined by the vehicle state determining unit 1.

In the fourth embodiment, an example in which the information displaying unit 11 is used to the information display device of the above-described third embodiment is described, but the information displaying unit 11 may also be used to the information display device of the above-described first and second embodiments.

In FIG. 11, a vehicle information acquiring unit 2, a vehicle state determination processing unit 3, a route determining unit 4, a display data storage unit 6, the display data selection processing unit 7, a display data processing unit 9, the surrounding situation monitoring unit 10, and the information displaying unit 11 being components of the information display device are assumed to be implemented by dedicated hardware illustrated in FIG. 10, that is, a vehicle information acquiring circuit 21, a vehicle state determination processing circuit 22, a route determination processing circuit 23, a display data storage processing circuit 24, a display data selection processing circuit 25, a display data processing circuit 27, a monitoring processing circuit 28, and the information display processing circuit 26, respectively.

However, the components of the information display device are not limited to those implemented by the dedicated hardware, and the information display device may also be implemented by software, firmware, or a combination of the software and firmware.

In a case in which the information display device is implemented by the software, firmware and the like, the display data storage unit 6 may be configured on the memory 41 of the computer illustrated in FIG. 3 and a program for allowing the computer to execute procedures of the vehicle information acquiring unit 2, the vehicle state determination processing unit 3, the route determining unit 4, the display data selection processing unit 7, the display data processing unit 9, the surrounding situation monitoring unit 10, and the information displaying unit 11 may be stored in the memory 41, and a processor 42 of the computer may execute the program stored in the memory 41.

Next, operations will be described.

However, components other than the information displaying unit 11 are similar to those in the above-described first to third embodiments, so that processing content of the information displaying unit 11 is herein mainly described.

The information displaying unit 11 holds a table illustrating a correspondence relationship between the state of the vehicle determined by the vehicle state determining unit 1 and a position on a road surface on which the information is displayed.

FIG. 12 is an illustrative view illustrating an example of the table held by the information displaying unit 11.

In the example in FIG. 12, the correspondence relationship indicating that a state of the vehicle S1 corresponds to a right side of the vehicle, a state of the vehicle S2 corresponds to a left side of the vehicle, and a state of the vehicle S3 corresponds to a right front side and the right side of the vehicle is recorded.

Herein, in order to simplify the description, the states of the vehicle are distinguished by S1, S2 and the like, but actually, as in the above-described first embodiment, they are determined such as automatic travel, formation travel, and starting from on-street parking.

Upon receiving the display data from the display data processing unit 9, the information displaying unit 11 refers to the table in FIG. 12 and specifies the position on the road surface corresponding to the state of the vehicle determined by the vehicle state determining unit 1.

For example, when the state of the vehicle is S1, the position on the road surface on the right side of the vehicle is specified, and when the state of the vehicle is S2, the position on the road surface on the left side of the vehicle is specified.

When displaying the information to the outside of the vehicle in accordance with the display data, the information displaying unit 11 displays the information at the specified position on the road surface by controlling the light irradiation unit 11a to irradiate the specified position on the road surface with light.

As is apparent from the above description, according to the fourth embodiment, the information displaying unit 11 is configured to switch the position on the road surface on which the information is displayed in accordance with the state of the vehicle determined by the vehicle state determining unit 1, so that even when the irradiation position information is not included in the display data stored in the display data storage unit 6, there is an effect that the information may be displayed in a position that is easy to see.

Although the example in which the information displaying unit 11 holds a table illustrating the correspondence relationship between the state of the vehicle determined by the vehicle state determining unit 1 and the position on the road surface on which the information is displayed is herein described, the table illustrating the correspondence relationship between the state of the vehicle determined by the vehicle state determining unit 1 and a medium on which the information is displayed may also be held.

FIG. 13 is an illustrative view illustrating an example of the table held by the information displaying unit 11.

In the example in FIG. 13, the correspondence relationship indicating that the state of the vehicle S1 corresponds to the road surface around the vehicle, the state of the vehicle S2 corresponds to the body of the vehicle, the state of the vehicle S3 corresponds to the window of the vehicle, the state of the vehicle S4 corresponds to a display tool formed of a plurality of light emitting devices and attached to the vehicle, and the state of the vehicle S5 corresponds to the display attached to the body and the like of the vehicle is recorded.

Upon receiving the display data from the display data processing unit 9, the information displaying unit 11 refers to the table in FIG. 13 and specifies the display medium corresponding to the state of the vehicle determined by the vehicle state determining unit 1.

For example, when the state of the vehicle is S1, the road surface around the vehicle is specified, and when the state of the vehicle is S2, the body of the vehicle is specified.

When displaying the information to the outside of the vehicle in accordance with the display data, the information displaying unit 11 displays the information on the specified display medium.

Also in this case, it is possible to obtain an effect of displaying the information in a position that is easy to see.

Meanwhile, in the invention of the present application, embodiments may be freely combined, any component of each embodiment may be modified, or any component may be omitted in each embodiment without departing from the scope of the invention.

### INDUSTRIAL APPLICABILITY

The information display device and the information display method according to the present invention are suitable for use in displaying the information to the outside of the vehicle.

### REFERENCE SIGNS LIST

1: Vehicle state determining unit, 2: Vehicle information acquiring unit, 3: Vehicle state determination processing unit, 4: Route determining unit, 5: Display data selecting unit, 6: Display data storage unit, 7: Display data selection processing unit, 8: Information displaying unit, 8a: Light irradiation unit, 9: Display data processing unit, 10: Surrounding situation monitoring unit, 11: Information displaying unit, 11a: Light irradiation unit, 21: Vehicle information acquiring circuit, 22: Vehicle state determination processing circuit, 23: Route determination processing circuit, 24: Display data storage processing circuit, 25: Display data selection processing circuit, 26: Information display processing circuit, 27: Display data processing circuit, 28: Monitoring processing circuit, 41: Memory, 42: Processor.

1-11. (canceled)

12. An information display device, comprising:
a plurality of display media; and
a processor configured,
to determine a state of a vehicle;
to select display data corresponding to the determined state of the vehicle from a plurality of display data for displaying information to be presented to an outside of the vehicle; and
to display the information on at least any one of the plurality of display media to the outside of the vehicle in accordance with the selected display data, and switch the display media on which the information is displayed in accordance with the determined state of the vehicle.

13. The information display device according to claim 12,
wherein the display data is animated display data including the information to be presented to the outside of the vehicle.

14. The information display device according to claim 12,
wherein the processor is configured to process the selected display data in accordance with the state of the vehicle,
wherein the processor is configured to display the information to the outside of the vehicle in accordance with the processed display data.

15. The information display device according to claim 14,
wherein the processor is configured to process the selected display data depending on a speed of the vehicle or a traveling direction of the vehicle.

16. The information display device according to claim 12,
wherein the processor is configured to monitor a situation around the vehicle and control display of the information in accordance with a monitoring result of the situation.

17. The information display device according to claim 12,
wherein the plurality of display media includes at least any one of a road surface around the vehicle, a body of the vehicle, a window of the vehicle, a display tool formed of a plurality of light emitting devices and attached to the vehicle, and a display attached to the vehicle.

18. The information display device according to claim 17,
wherein, in a case in which the information is displayed on the road surface around the vehicle, the processor is configured to switch a position on the road surface on which the information is displayed in accordance with the determined state of the vehicle.

19. The information display device according to claim 12,
wherein the processor is configured to determine whether the vehicle is stopping or the vehicle is traveling as the state of the vehicle, and, when the vehicle is traveling, the processor is further configured to determine whether the vehicle is in a manual traveling state in which the vehicle travels by manual operation, an automatic traveling state in which the vehicle travels by automatic operation, or a formation traveling state in which the vehicle travels in formation with other vehicles.

20. The information display device according to claim 19,
wherein the processor is configured to select display data for displaying information indicating that the vehicle is in the manual traveling state when the processor is configured to determine that the vehicle is in the manual traveling state, select display data for displaying information indicating that the vehicle is in the automatic traveling state when the processor is configured to determine that the vehicle is in the automatic traveling state, and select display data for displaying information indicating that the vehicle is in the formation traveling state when the processor is configured to determine that the vehicle is in the formation traveling state.

21. The information display device according to claim 19,
wherein the processor is configured to select display data for displaying information indicating that the vehicle starts in a case in which operation to start the vehicle is detected when the processor is configured to determine that the vehicle is stopping.

22. The information display device according to claim 12,
wherein the outside of the vehicle is a side surface or a side part of the vehicle.

23. An information display method, comprising:
determining a state of a vehicle;
selecting display data corresponding to the determined state of the vehicle out of a plurality of display data for displaying information to be presented to an outside of the vehicle;
displaying the information on at least any one of a plurality of display media to the outside of the vehicle in accordance with the selected display data; and
switching the display media on which the information is displayed in accordance with the determined state of the vehicle.
